(19) United States
(12) Patent Application Publication
(10) Pub. No.: US 2006/0157419 A1
(43) Pub. Date: Jul. 20, 2006

(54) Activated carbon exhibiting enhanced removal of dissolved natural organic matter from water

(75) Inventors: Tanju Karanfil, Clemson, SC (US); Seyed A. Dastgheib, Central, SC (US)

Correspondence Address: DORITY & MANNING, P.A., POST OFFICE BOX 1449, GREENVILLE, SC, 29602-1449, US

(73) Assignee: Clemson University

(21) Appl. No.: 11/036,085

(22) Filed: Jan. 14, 2005

(51) Int. Cl. C02F 1/28

(52) U.S. Cl. 210/694

(57) ABSTRACT

The invention is directed to methods for improving the DOM uptake of granular activated carbons and the carbons formed according to the methods. The methods include treating starting materials so as to provide a combination of physical and chemical characteristics favorable for DOM uptake. Particular methods utilized depend upon the characteristics of the starting materials but generally include at least one of: increase in surface area of the materials found in pores greater than 1 nm; increase in overall basicity of the materials; and impregnation of the materials with an iron species. The processed materials exhibit improved uptake of DOM from natural waters as compared to previously known GAC materials.

### FEDERALLY SPONSORED RESEARCH AND DEVELOPMENT

The United States government may have rights to this invention pursuant to United States Environmental Protection Agency Grant No. R-82815701-0.

### BACKGROUND OF THE INVENTION

Natural waters, i.e., ground or surface waters, rather than being pure water, may contain contaminants that must be removed prior to delivery of the water to consumers. For example, man-made products including petroleum products, waste materials, and pesticides and herbicides utilized in farming and gardening often contaminate natural water sources through spills, improper disposal, over application combined with run-off, and the like. In addition, naturally occurring organic and inorganic materials often exist in natural water that, though naturally occurring, are still undesirable materials for delivery to consumers.

As a result, a great deal of research has gone into developing methods and materials that can be utilized to remove undesirable constituents from natural waters. For example, flocculants and other chemicals can be added to water to convert the undesirable constituents into forms that can be more easily separated from the water through, e.g., settling and/or filtering. In addition, materials having a specific affinity for certain contaminants have been developed that can separate the unwanted constituents from water during processing. In addition, activated carbon has been used effectively to remove some undesired materials from natural waters. For example, particularly designed and functionalized activated carbon materials have been found highly effective for removal of many small molecular weight hydrophobic synthetic organic contaminants such as aromatics (e.g., benzene), organic heavy metal complexes (e.g., chromium and mercury complexes), and small (C1-C3) halogenated hydrocarbons, among others.

Unfortunately, activated carbon materials have not been particularly effective at removing other types of unwanted materials from natural waters. In particular, activated carbon materials have proven less than desirably effective for removing complex and macromolecular natural organic materials from natural waters, primarily due to low equilibrium capacities and slow adsorption kinetics of the organic materials by the activated carbons. In attempting to remove such organic materials, and in particular, dissolved organic matter, the materials have been shown to react with oxidants or other disinfectants such as chlorine to form carcinogenic disinfection byproducts during water treatment operations.

What is needed in the art are improved methods and materials capable of removing naturally occurring complex and macromolecular organic matter from natural waters.

### SUMMARY OF THE INVENTION

In general, the disclosed invention is directed to methods for forming granular activated carbons (GAC) so as to provide product GAC that can exhibit improved uptake of dissolved organic matter (DOM) as compared to previously known GAC. The invention is also directed to GAC that can be formed according to the disclosed processes and methods for removing DOM from natural waters through utilization of the disclosed GAC.

For instance, in one embodiment, the disclosed methods can include providing a carbon-based material suitable for forming a GAC, i.e., a raw material suitable for forming a GAC, a previously formed GAC, or an intermediate material formed during a GAC formation process, and impregnating the carbon-based material with an iron species so as to improve uptake of DOM by the product GAC. For example, the carbon-based material can be impregnated with one or more iron species having an oxidation state of +2 and/or +3 such as an iron oxide, an iron hydroxide, an iron salt, or an organic iron compound. The disclosed product GAC materials can thus include an amount of impregnated iron, for example, at least about 1% by weight.

The GAC formation process can also include various standard GAC formation steps as are generally known in the art such as, for example, granulation of the carbon-based material at an appropriate point in the overall process. In general, there is no particular order required for carrying out the disclosed processing steps of the starting carbon-based materials to form the product GAC.

The product GAC of the invention can also define a suitable amount of surface area in pores of a size accessible to DOM. For instance, the GAC can define a surface area that includes at least about 100 m²/g in pores greater than about 1 nm in size. In one embodiment, the GAC surface area can include at least about 500 m²/g in pores greater than about 1 nm in size. Accordingly, in one embodiment, the methods can include increasing the surface area that is accessible to DOM of the carbon-based material that can form the GAC. In particular, the methods can include increasing the amount of the surface area of the carbon-based material that is distributed in pores greater than about 1 nm in size.

The disclosed methods can also include increasing the overall positive surface charge of the carbon-based material. For example, the methods can include increasing the overall positive surface charge of the carbon-based material as measured by the pH_{PZC} by at least about 4 pH units. In one embodiment, the disclosed product GAC materials can have a pH_{PZC} of at least about 7. In another embodiment, the product GAC can have a pH_{PZC} of at least about 9.

In one embodiment, the DOM uptake of a GAC can be improved through increasing the basicity of the carbon-based material during the formation process. For example, following formation, the product GAC materials of the invention can exhibit basicity, as measured by uptake of HCl, of at least about 0.2 meq/g. In one embodiment, the product GAC can exhibit an HCl uptake of at least about 0.4 meq/g. In another embodiment, the product GAC can exhibit an HCl uptake of at least about 0.5 meq/g.

In general, any suitable processing methods as are generally known in the art can be utilized to obtain the desired combination of physical and chemical characteristics on the GAC materials. For example, in one embodiment the carbon-based material can be subjected to a heat treatment at any appropriate point during GAC formation by holding the material at a high temperature in an oxygen deprived atmosphere, for instance under a hydrogen or helium blanket or under steam. This particular process can be utilized, for example, to increase the basicity of the materials, and in some embodiments to also open the pores of the materials.

Optionally, the GAC formation process can include contacting the carbon-based materials with ammonia gas. Moreover, if desired, the ammonia gas can be heated, for instance heated to a temperature greater than about 500° C. In one embodiment, the materials can be oxidized prior to the ammonia treatment.

The invention is generally directed to any carbon-based starting materials suitable for forming GAC. For example, the starting materials can include wood, coal, peat, pitch, tar, recycled waste materials, and mixtures thereof. In other embodiments, the starting materials can include a previously formed GAC.

When contacted with natural waters comprising dissolved organic carbon (DOC), the disclosed product GAC can successfully and efficiently remove DOM from the water.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, in which:

FIG. 1 graphically compares the adsorption isotherms of dissolved organic carbons from natural waters for a virgin coal-based GAC material to the same material following processing according to various embodiments of the present invention.

FIG. 2 graphically compares the adsorption isotherms of dissolved organic carbons from natural waters for the virgin coal-based GAC material of FIG. 1 to the same material following iron impregnation alone as well as following iron impregnation in conjunction with other processing techniques according to various embodiments of the present invention.

FIG. 3 graphically compares the adsorption isotherms of dissolved organic carbons from natural waters for a virgin wood-based GAC material to the same material following processing according to various embodiments of the present invention.

FIG. 4 graphically compares the adsorption isotherms of dissolved organic carbons from natural waters for the virgin wood-based GAC material of FIG. 3 to the same material following iron impregnation alone as well as following iron impregnation in conjunction with other processing techniques according to various embodiments of the present invention.

### DEFINITION OF TERMS

For purposes of this disclosure, the following terms and acronyms are defined as follows:

Naturally occurring organic material (NOM)—a heterogeneous mixture of complex and mostly macromolecular organic materials. A non-limiting exemplary list of NOM can include, for example, humic substances, hydrophilic acids, proteins, lipids, carboxylic acids, polysaccharides, amino acids, and hydrocarbons. NOM as encompassed in the present invention can include materials in dissolved, colloidal or particulate forms.

Dissolved organic matter (DOM)—The components of NOM capable of passing through a 0.45 micrometer (μm) filter.

Dissolved organic carbon (DOC)—the amount of organic carbon by weight in a natural water sample.

Disinfection byproducts (DBP)—reaction products formed during water treatment as a result of reaction between DOM and added reactants such as oxidants or other disinfectants such as chlorine.

Granular activated carbon (GAC)—a carbon-based material in granular form that has been treated to promote the formation of sites that can adsorb specific materials. Two forms of GAC typically utilized include coal-based activated carbon and wood-based activated carbon.

Microporous activated carbon—Activated carbon comprising a majority of its surface area distributed in pores less than about 2 nm.

Mesoporous activated carbon—Activated carbon comprising a majority of its surface area distributed in pores between about 2 nm and about 50 nm.

Carbon-based material—for purposes of this disclosure, the term can optionally refer to unprocessed or preprocessed, raw starting materials suitable for forming a GAC, GAC product materials, as well as intermediary materials developed during a multi-step GAC formation process.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used in another embodiment to yield a still further embodiment. Thus, it is intended that the present invention cover such modifications and variations as come within the scope of the appended claims and their equivalents.

In an on-going effort to protect the general public from undesirable materials in water delivered to homes and offices, governments are imposing increasingly stringent limitations on acceptable levels of contaminants found in water, including acceptable DBP levels. The most obvious method for decreasing DBP levels is through removal of their precursors, that is, DOM. Accordingly, the present invention provides materials and methods for removal of DOM from natural waters, and thus in one embodiment, the disclosed invention can provide methods and materials to improve the quality of water delivered to the general public.

According to one embodiment of the present invention, granular activated carbons exhibiting improved affinity for DOM are disclosed. More specifically, the GAC of the invention have been specifically designed so as to improve and enhance the adsorption of DOM by the GAC. In particular, it has been discovered that improved performance of GAC with respect to DOM adsorption can be attained through development and formation of GAC materials exhibiting particular physical characteristics in combination with particular chemical characteristics.

The invention is also directed to methods for forming activated carbon materials so as to improve the affinity of the product GAC for DOM. In particular, the invention is directed to methods for developing the beneficial combination of physical and chemical characteristics in activated carbon materials so as to improve the adsorption characteristic of the GAC for DOM. Primarily depending upon the characteristics of the starting carbon-based materials, various steps can be carried out so as to provide the disclosed GAC materials exhibiting enhanced adsorbability of DOM.

When considering the ability of GAC to adsorb DOM from a purely chemical perspective, it is necessary to consider the chemical characteristics of DOM and the surface chemistry of GAC as well as general solution chemistry. For example, DOM in natural waters is typically a heterogeneous mixture of acidic macromolecules. Accordingly, in one embodiment, the GAC product materials of the invention can exhibit basic surface characteristics so as to be more favorable to uptake of acidic DOM.

In addition to being acidic, many DOM components carry a negative charge. As such, DOM uptake would be expected to be improved by processes that can increase the positive surface charge of the product materials, which has, in fact, been found to be the case in the presently disclosed materials.

Specific functionalities can also be developed on the surface of the disclosed materials so as to improve the materials' affinity for DOM. For instance, certain nitrogen-containing functionalities, such as, for example, amide, imide, imine, amine, and nitrile functionalities, when formed on the surface of certain carbon-based materials, are believed to, in some embodiments, contribute to the improved affinity of the product GAC for DOM.

In addition, GACs impregnated with certain functionalities have been shown to exhibit increased affinity for DOM. More specifically, according to the present invention, it has been shown that the presence of certain species, and in particular certain iron species, can improve the uptake of DOM by the GAC. This is believed to be due not only to the electrostatic attraction between the iron species and the largely anionic DOM, but also due to the complex-forming capability of the iron species with DOM components that have available electron pairs. Specifically, impregnation of carbon-based materials with iron species has been shown to increase the affinity of the product GAC for DOM. In particular, impregnation of GAC with iron species having oxidation states of +2 and/or +3, when combined with other desirable physical and/or chemical characteristics, can improve the affinity of the GAC materials for DOM.

In combination with the chemical characteristics discussed above, the disclosed GAC materials can also exhibit particular physical characteristics that can contribute to the improved DOM uptake shown by the materials. More specifically, the disclosed materials can have at least a portion of the surface area distributed in pores with sizes larger than about 1 nm, so as to provide increased accessibility of DOM macromolecules to the GAC surface. In one specific embodiment, the disclosed materials can have a large amount of supermicroporosity and mesoporosity. Due to the amount of the surface area distributed in relatively large pores, physical access of the DOM macromolecules to the beneficial surface chemistry of the GAC can be optimized, and thus the physical characteristics of the disclosed materials can effectively enhance the presence of a desirable surface chemistry in the materials and further improve the DOM uptake by the disclosed GAC.

As previously discussed, it is the combination of physical characteristics and chemical characteristics in the disclosed materials that encourage the improved uptake of DOM. More particularly, it is a combination of the surface area of the materials available to the DOM, which can be characterized by the amount of the surface area found in pores greater than about 1 nm in size, with the beneficial surface chemistries, for instance the surface basicity and the positive surface charge of the materials, that can provide the improved DOM uptake of the product materials. In addition, particular surface chemistries can be developed on the products that can also contribute to the improved performance. In particular, the addition of particular species at the surface of the carbon can also contribute to the performance of the materials.

As it is a combination of physical and chemical characteristics that can provide the disclosed product materials with the improved affinity for DOM, the characterization of any one particular physical or chemical parameter of the product GAC generally will not be enough to characterize the disclosed product materials as capable of showing improved DOM uptake.

For example, in some embodiments, the disclosed product materials can have a relatively low amount of surface area distributed in pores greater than about 1 nm in size, for instance less than about 300 m²/g. In one particular embodiment, the product materials can have between about 100 m²/g and about 300 m²/g of the surface area distributed in pores greater than about 1 nm in size. In such embodiments, processes that can develop beneficial surface chemistry on the materials can contribute relatively more to the improved affinity for DOM shown by the products.

For example, in one embodiment, the formation process can include starting with or optionally developing a carbon-based material having between about 100 m²/g and about 300 m²/g of the surface area distributed in pores greater than about 1 nm in size. In this embodiment, it may be preferable to utilize a particular product formation process that can include increasing the positive surface charge of the carbon-based materials. For purposes of this disclosure, the positive surface charge of the carbon-based materials has been quantified by reference to the pH of point of zero charge (pH_{PZC}). For instance, the carbon-based materials can be processed such that the pH_{PZC} of the product GAC is greater than about 9. In this particular embodiment, the high positive surface charge of the product materials can effectively counteract the effect of the relatively small amount of surface area available to the large DOM molecules.

In certain embodiments, the formation process can include steps so as to increase surface basicity of the carbon-based materials, which is also conducive to DOM uptake. In the present application, basicity has been quantified through measure of the uptake of the materials of HCl in meq/g (millequivalent per gram), though other measures of basicity of the materials are known and may alternatively be utilized. For example, in one embodiment, the product GAC of the materials can have a relatively low amount of surface area available for contact with the large DOM molecules, for example, less than about 300 m²/g of surface area found in pores greater than about 1 nm. However, in this embodiment, the product formation methods can include one or more processes that can increase basicity of the materials as measured by the HCl uptake of the material to a value of, for example, greater than about 0.4 meq/g, and thus provide a product GAC exhibiting high DOM uptake.

In other embodiments, the physical characteristics of the product GAC can contribute more to the overall performance of the materials. In particular, the product materials can exhibit improved DOM uptake over GAC materials known in the past, even though certain chemical characteristics of the product materials may not be necessarily as advantageous when viewed in isolation. For example, in one embodiment, the GAC products can include a large amount of the surface area in pores greater than 1 nm, for example, greater than about 300 m²/g, and the pH_{PZC} of the materials can be lower than those of the embodiments discussed above, in particular, the pH_{PZC} can be less than 9. Thus, the physical characteristics of the product GAC can contribute relatively more to the DOM uptake in embodiments in which the chemical characteristics are not as highly optimized during formation as in the embodiments described above. For instance, improved DOM uptake can be attained in products in which more than about 300 m²/g of the surface area can be found in pores greater than 1 nm and the pH_{PZC} can be less than 8, or even lower yet, less than 7, in some embodiments. In other embodiments, the amount of the surface area in pores greater than about 1 nm in size can be larger yet, for example, greater than about 500 m²/g.

In some embodiments, the starting carbon-based materials can be processed so as to provide a GAC product in which the basicity can be high, and this can be combined with a somewhat lower surface area positive charge and/or a lower amount of the surface area of the materials in large pores, but the products can still show improved DOM uptake as compared to previously known GAC materials. For example, in one embodiment, the product GAC can exhibit a pH_{PZC} of less than about 7 but can also exhibit greater than about 0.50 meq/g uptake HCl so as to provide improved DOM uptake of the materials.

In other embodiments, the physical characteristics of the product materials can contribute a larger compensating factor when combined with a somewhat lower positive surface charge and/or a lower basicity. For example, in one embodiment, the starting carbon-based materials can be etched or otherwise processed to increase the porosity of the materials such that the amount of surface area of the GAC product in pores greater than about 1 nm can be quite large, for example, greater than 500 m²/g, and when combined with a positive surface charge and a basicity that is not necessarily as high as values for these particular parameters found in other embodiments, the product materials can still exhibit improved DOM uptake. For example in certain embodiments, the product GAC materials can exhibit a porous structure with a great deal of the surface area in large pores, for example, greater than 500 m²/g in pores larger than about 1 nm, the pH_{PZC} can be between about 6.5 and about 7.5 and the HCl uptake can be between about 0.02 and about 0.30 meq/g, and the product GAC can exhibit improved DOM uptake as compared to existing GAC.

In yet another embodiment, the basicity of the product GAC can be relatively low, with HCl uptake less than 0.10 meq/g, for example, and the other parameters can contribute relatively more to the improved DOM uptake characteristics of the materials. For example, the amount of surface area of the materials in pores greater than about 1 nm can be greater than about 400 m²/g and the pH_{PZC} can be greater than about 7 in a GAC exhibiting relatively low overall basicity, and the materials can still exhibit improved affinity for DOM.

Other characteristics can also contribute to the improved performance of the disclosed materials. For example, in some embodiments, the carbon-based materials can be impregnated or derivatized with particular ions or functional groups that can show an affinity for DOM. In one particular embodiment, the materials can be impregnated with an iron species, and in particular, iron species having oxidation states of +2 and/or +3. The presence of an iron species on the products can not only increase the overall surface affinity of the GAC for DOM, but is also believed to encourage the formation of iron complexes with DOM. As such, the presence of the iron species in the materials can be utilized in conjunction with the parameters discussed above for improving the DOM uptake of the materials. For example, in one embodiment, the HCl uptake can be quite low, less than about 0.10 meq/g and the percentage of surface area of the materials in pores greater than about 1 nm can also be relatively low, such as between about 200 m²/g and about 300 m²/g, but the products can still exhibit improved uptake of DOM as compared to previously known GAC due to, it is believed, the presence of iron species on the surface of the materials that can provide both an increased surface affinity for DOM as well as complex-forming capability with the DOM. For instance, in one embodiment, the disclosed GAC materials can include at least about 1% iron by weight. In other embodiments, the materials can include higher iron contents, for example, greater than 2%, greater than 5%, greater than 7%, or greater than 9%, in some embodiments.

The disclosed GAC materials can be very effective at adsorbing DOM from natural water. For example, at a constant temperature of about 22° C., the disclosed materials can, in one embodiment, adsorb more than 20.0 mg DOC per gram carbon, though any particular numerical amount of DOM adsorption will obviously depend upon the amounts of materials in the water to be treated and the treatment conditions. In one embodiment, the GAC materials can adsorb more than 25.0 mg DOC per gram GAC at a constant temperature of about 22° C.

There are many known processing techniques that can be utilized in forming the disclosed materials, among other factors. In general, the preferred processing techniques can depend upon the characteristics of the starting material. For example, wood-based GAC materials formed from wood, wood chips, saw dust, and the like, can often have a large volume of surface area in meso- and macropores upon initial formation. In addition, many wood-based GAC materials are very acidic upon initial formation. As such, according to one embodiment of the present invention, a wood-based GAC can be formed including steps in the formation process for the purpose of increasing the basicity of the final GAC product and optionally to increase the positive surface charge of the product material through, for instance, the impregnation of an iron species, and thus the product materials can exhibit improved affinity for DOM in natural waters as compared to previously known wood-based GAC materials.

In another embodiment, the starting material can be a coal, such as, for example, any or all of bituminous coal, subbituminous coal, or lignite. Coal-based GAC formation processes often develop materials exhibiting relatively little total surface area in large pores, but having a relatively high positive surface charge. According to this particular embodiment, processing techniques may be preferred that can increase the porosity of the material and, optionally, increase the overall basicity of the material.

Generally, any carbon-based material suitable for forming GAC as is known in the art can be utilized as a starting material for the disclosed process. Particular formation processes and any particular order in which individual steps in the formation processes can be carried out can be optimized as is generally known in the art for that particular starting material. For instance, in addition to wood and coal, as mentioned above, other materials rich in carbon can be employed as a starting material including, but not limited to: agricultural products, such as nut shells and coconut shells; peat; pitches; cokes, including coal-based coke and petroleum-based coke; petroleum fractions, such as tars; and carbon-based waste materials including tires, carbon-based household waste, carbon-based waste polymeric materials, sewage, sludge, and other carbon-based solid wastes. In another embodiment, the starting material can be a previously formed GAC material, and the present invention can be considered post-processing of the GAC to improve DOM uptake of the previously formed material.

Following is a discussion of several known processing techniques that can be utilized in forming the disclosed materials and some of the overall effects each technique can have on a product GAC. It should be understood, however, that any particular processing techniques discussed are not required in the practice of the disclosed invention and are included as examples of techniques that can be utilized in forming the disclosed materials. Other equally suitable techniques as are generally known in the art can optionally be utilized for enhancing the physical and/or chemical characteristics of a product GAC material toward adsorption of DOM.

Granulation

The need for as well as the preferred method for granulation of the carbon-based materials, as with other processing techniques discussed below, can depend at least in part upon the nature of the starting materials used in the process. For example, in one embodiment, the product GAC can be a coal-based material. According to this embodiment, the GAC formation process can include granulation of the material that can include pulverization of the coal, formation of the pulverized powder into small blocks or briquettes, and subsequent crushing and screening of the blocks to produce granules of the desired size.

In other embodiments, other granulation methods may be preferred, however. For example, in other embodiments, a wet extrusion granulation or a mixer granulation method may be preferred. A wet extrusion granulation can include pulverization of the carbon-based material to form a powder, mixing of the powder with a liquid to a semi-solid consistency, and extrusion of the mixture through a die to provide the desired granule size. The extrudate can then optionally be shaped, for instance, to form spherical granules. Mixer granulation includes placing of the pulverized powder into a mixer, and addition of a liquid binder during a mixing process in order to wet the powders and form granules. Other granulation methods as are generally known in the art may optionally be utilized as well.

Heat Treatment

Heat treatment of carbon-based materials in an oxygen deprived environment, for instance, heat treatment at about 900° C. for about 2 hours under helium, hydrogen, or steam can be utilized to remove a considerable portion of oxygen surface functionalities on the materials and can also decrease the surface acidity. Heat treatment can also lead to structural changes in certain carbon-based materials. For instance, heat treatment can lead to decreases in surface area and pore volume as well as changes to the pore size distribution. Such structural changes can be observed, for instance, following heat treatment of wood-based, mesoporous carbon-based materials, whereas heat treatment can have relatively little effect on the physical structure of microporous materials.

In one particular embodiment, a carbon-based material can have a relatively low surface acidity and little surface area distributed in large pores. According to this embodiment, heat treatment alone can offer significant improvements in DOC uptake of the product GAC materials. For example, heat treatment under hydrogen or helium of a coal-based, microporous carbon-based material can substantially improve DOC uptake in the product. In other embodiments, however, and generally depending upon the characteristics of the starting carbon-based materials, it may be preferred to subject the starting materials to other particular treatment processes, such as those described below, or optionally to a heat treatment process in addition to one or more other formation processes.

Oxidation

Oxidation of a carbon-based material can be carried out in one embodiment through contacting the materials with an oxidizing agent that can be in either the steam or liquid phase. For example, the materials can be oxidized through contact with gaseous oxygen or steam or with an oxidizing solution such as a solution of hydrogen peroxide, nitric acid, perchloric acid, and the like, optionally while the materials are held at a high temperature. For example, the materials can be oxidized by contacting the materials with a hot (e.g., boiling) acid for a period of time (e.g., about an hour).

Oxidation can produce highly acidic GAC, and thus when utilized alone, may not generally improve the DOM uptake of the materials. This process can be advantageously utilized with other known processes in some embodiments of the present invention, however. For example, this process can be utilized as a pre-treatment to prepare the materials for subsequent nitridation treatment and/or iron impregnation and can improve the effect of these subsequent processes.

Nitridation

While not wishing to be bound by any particular theory, it is believed that addition of nitrogen-containing functionalities to the surface of carbon-based materials can increase DOM affinity of activated carbons due to both the chemical changes brought about to the materials by the process as well as due to physical changes that the materials can undergo during certain nitridation processes. For example, when nitridation processes are performed, such as, for example, subjection of the materials to gaseous ammonia, and particularly when such processes are carried out at high temperatures (e.g., greater than 500° C.), decomposition of acidic functional groups during the process can increase the overall basicity of the materials. The reactive surface sites that can become available due to decomposition of acidic groups can then be available for reaction with the nitrogen-containing reactant for forming or depositing new basic nitrogen-containing functionalities on the surface. Nitridation at either high or low temperatures can also improve the carbon-based material's surface basicity by neutralizing surface acidities.

Reactivity of certain nitrogen containing reactants, such as ammonia gas, for example, with a carbon-based material's surface can increase along with consequent development of nitrogen-containing groups depending upon the material's oxygen content. Thus, in certain embodiments of the invention, it may be preferred to oxidize the carbon-based material via, e.g., nitric acid oxidation, prior to nitridation. Pre-oxidation of the materials prior to any ammonia treatment is not a requirement of the present invention, however. For instance, while pre-oxidation of the materials prior to nitridation treatment can enhance both incorporation of nitrogen functionalities to the carbon surface and surface etching of the materials, as described below, ammonia treatment without pre-oxidation can improve the GAC product materials, in particular due to creation of nitrogen functionalities and increase in overall surface basicity of the materials.

Formation of particular nitrogen-containing functional groups at the surface of the GAC can optionally be controlled through particular selection of the nitrogen-containing reactant as well as through control of process temperature and reaction time. For example, higher treatment temperatures and longer treatment times in nitridation processes involving contact of the materials with a nitrogen-containing gaseous reactant, such as ammonia, for example, can shift the initially formed functionalities from amine and amide to imine and imide and finally to nitrile and pyridine.

Various nitridation methods can be utilized in the disclosed processes. For example, in addition to contact with gaseous ammonia, discussed above, the materials can be subjected to a chemical vapor deposition process that can deposit a nitrogen-containing material from the vapor phase onto the surface. For example, CVD of pyridine can be used for addition of nitrogen functionalities on the surface of the materials. Other particular nitrogen functionalities that can be formed or deposited on the surface through nitridation can include, for example, amides, imides, imines, amines, and nitrile functionalities.

Pore Opening

Uptake of DOM by GAC can also be enhanced through optimization of physical characteristics of the starting materials. In particular, methods that can increase the surface area of the products available for reaction with the large DOM molecules can be utilized in the disclosed processes to enhance the materials. Obviously, pore opening processes can be more beneficial when processing materials that have a relatively low amount of surface area distributed in large pores, for example, in starting or intermediate materials having less than about 300 m²/g of the surface area distributed in pores greater than about 1 nm in size.

In one embodiment, a surface etching process can be utilized including pre-treatment oxidation of a carbon-based material followed by contact of the oxidized material with gaseous ammonia. Such a process can be utilized to enlarge carbon pores of the materials and can thus improve the DOM uptake of the disclosed materials.

Other pore opening processes as are generally known in the art can optionally be utilized in the presently disclosed process. For example, other processes including steam treatment, activation under steam, treatment with a mixture of steam with various reactive gases (e.g., CO₂), and the like can be utilized. The particular pore opening treatment process preferred for any particular embodiment of the disclosed invention can depend upon the characteristics of the starting material, the point in the overall preparation process at which the pore opening operation takes place, the other possible effects to the product carbon of the particular pore opening treatment selected, and economic factors, among other considerations.

Impregnation

In one embodiment, impregnation of the carbon-based materials with a particular species can be effected via ion exchange or excess solution methods as are generally known in the art. Ion exchange methods generally require a certain amount of oxidation of the materials prior to the process, however. As such, in certain embodiments, pre-treatment of the material prior to the impregnation step so as to increase oxygen content of the materials may be preferred. In addition, in certain embodiments, the carbon surface can become further oxidized during the impregnation process. Since surface oxidation can have a negative impact on the DOM uptake of the product materials, in some embodiments, it may be preferred to minimize any excess surface acidity of the GAC following an impregnation process via, for example, a nitridation process such as high temperature ammonia treatment.

The present invention may be better understood with reference to the following examples.

### Processing Techniques and Designations

The following particular experimental techniques and designations were utilized in the Examples that follow. However, it should be understood that any particular method utilized and the particular conditions under which the processes have been carried out are for exemplary purposes only, and other methods and processes can be optionally utilized in forming and characterizing the disclosed materials. In addition, optimization of the conditions of any particular process can be dependent upon, among other factors, starting materials, economic considerations, as well as scale of the described process. As such, it should be understood that the particular processes and conditions (e.g., pH, temperature, etc.) described below are for exemplary purposes only, and are not intended to limit the present invention in any way.

Heat treatment: A sample was placed in a vertically positioned tubular quartz reactor within a tubular furnace. Samples (between about 5 and 10 grams) were treated for 2 hours at 900° C. under either helium or hydrogen flow. Samples treated under helium flow are designated He in the following tables and accompanying figures. Samples treated under hydrogen flow are designated H in the following tables and accompanying figures.

Oxidation: Oxidation in liquid phase was performed by boiling about 6 grams of a sample in 150 mL concentrated (15.7N) nitric acid for one hour. The sample was then filtered, thoroughly washed with deionized water, dried at 90° C., and stored. Nitric acid oxidized samples are designated 16NO in the following tables and accompanying figures.

Nitridation: Samples were nitrided by anhydrous ammonia treatment. Approximately 5 grams of sample was placed in a quartz tube reactor and treated with anhydrous ammonia for one or two hours at three possible temperatures: 300° C., 400° C., or 800° C. The samples were filtered, thoroughly washed with deionized water and dried at 90° C. When reading the following tables and accompanying figures, the first number in the ammonia treatment designation identifies the treatment temperature, i.e., 3 designates a treatment temperature of 300° C., 4 for 400° C., and 8 for 800° C. The second number designates the treatment time; 1 for one hour and 2 for two hours. Thus, the designation 3N1H indicates treatment of the sample with ammonia at 300° C. for 1 hour, while 8N2H indicates ammonia treatment at 800° C. for 2 hours, etc.

Iron impregnation: Iron impregnation of samples was performed according to two different methods. In the ion exchange method, 150 mL of 0.2 mol/L ferric chloride was added to about 7 grams of GAC. The carbon slurry was shaken for 2 days at room temperature at 150 rpm to reach equilibrium, and then filtered, washed several times with deionized water, dried at 90° C., and stored. Samples treated with ferric chloride are designated Fe3E. In a second method, a modified excess solution impregnation method, 100 mL of 0.2 mol/L ferric chloride was added to about 10 grams GAC. The carbon slurry was placed in a drying oven overnight to evaporate water. The sample was then heat treated under helium flow at 900° C. for 1 hour, washed with deionized water several times, and dried at 90° C. Iron-impregnated carbon with heat treatment under helium is designated FeS,He in the following tables and accompanying figures.

Water source: The water containing DOM that was treated in the following examples was collected from the influent to the Myrtle Beach (MB) drinking water treatment plant in Myrtle Beach, S.C., USA. The water was collected and concentrated using a reverse osmosis system. Mass balance calculations showed that over 95% of the DOM was recovered from the source during RO isolation.

Elemental Analysis: For determination of iron, the carbon samples were digested in concentrated nitric acid at 180° C. for 30 min by a microwave digestion device. Filtered and diluted solutions were analyzed by Inductively Coupled Plasma Atomic Emission Spectroscopy for determination of various elements including phosphorus and iron.

Total acidity and basicity: The concentration of total acidic and basic groups on carbon surfaces was determined from NaOH or HCl uptake. Several 25 mL vials, each with 100 mg of carbon sample, were prepared and filled with 20 mL of 0.05N NaOH or 0.05N HCl. Vials without carbons were also prepared and served as blanks. Samples and blanks were shaken at 200 rpm for 48 hr at room temperature, and then left for 6 hr for settling of carbons. Ten milliliter of the solution was titrated with 0.05N of either NaOH or HCl solution. The difference between the NaOH or HCl consumption by the blank and samples was calculated and translated to the equivalent acidity or basicity per gram of carbon. The relative standard deviation of results, determined from replicate experiments of selected samples, was less than 6%.

For iron-impregnated samples, iron species were partially leached to the HCl solution during the equilibration period. The leached iron ions were precipitated when the solution was titrated with NaOH. To check the effect of leached iron on the acid uptake of carbon, the same HCl uptake experiment was performed using ferric hydroxide. Although ferric hydroxide was partially dissolved in the HCl solution but due to later precipitation during the NaOH titration, the HCl uptake was similar to that of the blank solution (i.e., close to zero). Therefore, iron leaching did not have an impact on the HCl uptake values reported here, representing the amount of total basic groups on the iron-impregnated carbon samples.

pH of point of zero charge (DH_{PZC}): One-tenth molar NaCI solutions having different pH values (2-11) were prepared using distilled and deionized water that was boiled for removal of dissolved CO₂. Solutions of 0.5N HCl or NaOH were used in pH adjustment. One hundred milligram carbon samples were contacted with 20 mL of 0.1 M NaCl solutions with different initial pH values in 25 mL vials. Blanks with no carbon were also run with the samples. Duplicate experiments were performed on randomly selected samples. Sealed vials were shaken for 48 hr at 200 rpm at the room temperature, and then left for 6 hr for settling of carbons. The final pH of the solution was measured. The pH_{PZC} was determined as the pH of the NaCl solution that did not change after the contact with the samples. Replicate tests showed that the reproducibility of pH_{PZC} values was in the range of ±0.2.

For iron-impregnated carbons, leaching of iron to the solution (at low pH values) may introduce some errors to the pH_{PZC} tests. Monitoring the iron concentration in solution during these experiments showed a significant leaching below the pH of 3. Therefore, the most acidic solution used for the pH_{PZC} determination of iron-impregnated carbons had a pH of 4.

X Ray Photoelectron Spectroscopy (XPS): Surface elemental analysis of selected samples was performed using XPS technique by the Materials Characterization Laboratory of Pennsylvania State University. The analyzed spot size was 700 μm·350 μm, and the average depth of analysis was estimated at 25 Å. Samples were analyzed to: (1) find the elemental composition of the surface; and (2) determine ionic and non-ionic states of the dispersed iron, in the case of iron-impregnated carbons.

Surface area and pore size distribution analysis: Surface area and pore size distribution of samples were determined from adsorption isotherms of nitrogen from relative pressure of 10⁻⁶ to 1 at 77K. Surface area of samples was calculated from BET equation (SA_{BET}). The relative pressure ranges used in BET calculations were from 0.01 to 0.1 and 0.05 to 0.2 for microporous and mesoporous activated carbons, respectively. Pore size distribution of activated carbon samples was determined from the nitrogen isotherms using Micromeritics' DFT (Density Functional Theory) software by assuming the graphite model with slit shape geometry.

The total pore volume was calculated from the adsorbed volume of gas near the saturation point (P/P₀=0.98). Micropore volume was calculated by using Dubinin-Radushkevich equation in the relative pressure range of 10⁻⁵ to 10⁻¹. By subtracting micropore volume from the total volume, total meso- and macropore volume (vₘₑ+vₘₐ) was determined. Reproducibility of measurements was determined from triplicate data of randomly selected samples. RDS (relative standard deviation) of BET surface area, micropore volume (DR), and total pore volume were less than 3%.

Adsorption isotherms: Constant-dose bottle point isotherm experiments with a wide range of initial DOM concentrations were performed for the MB water. Fifty milligrams of carbon was placed in each ˜130 mL amber bottle. One hundred milliliter of DOM solution, having a target concentration between 0 and 20 mg/L TOC, prepared in a 0.01 M NaCl background (providing approximately 2000 μS/min conductivity for all of the solutions), was added in each bottle. Two types of blanks served as controls during the isotherm experiments: bottles containing solutions with various DOM concentrations but without any adsorbent, and bottles containing carbons in contact with distilled and deionized water. In order to check the reproducibility of the experiments, at least one randomly selected duplicate point was included in each isotherm. Sealed bottles were placed on a rotary tumbler for 14 days at the room temperature (22±2° C.). The pH of the water during the adsorption experiments ranged from 6.5 to 7.5. After two weeks of contact time, solutions (including blanks) were filtered using a pre-washed membrane filter (0.45 m Supor, Gelman, Ann Arbor, Mich., USA), and analyzed for dissolved organic carbon (DOC) concentration using a high temperature combustion analyzer (TOC-5000, Shimadzu, Kyoto, Japan). The relative standard deviation of isotherm results was less than 5%. Iron concentration was monitored for isotherm experiments with the iron-impregnated carbons using Inductively Coupled Plasma Atomic Emission Spectroscopy (Thermo Jarrell Ash Model 61E) and no leaching of iron into the solution was observed.

### EXAMPLE 1

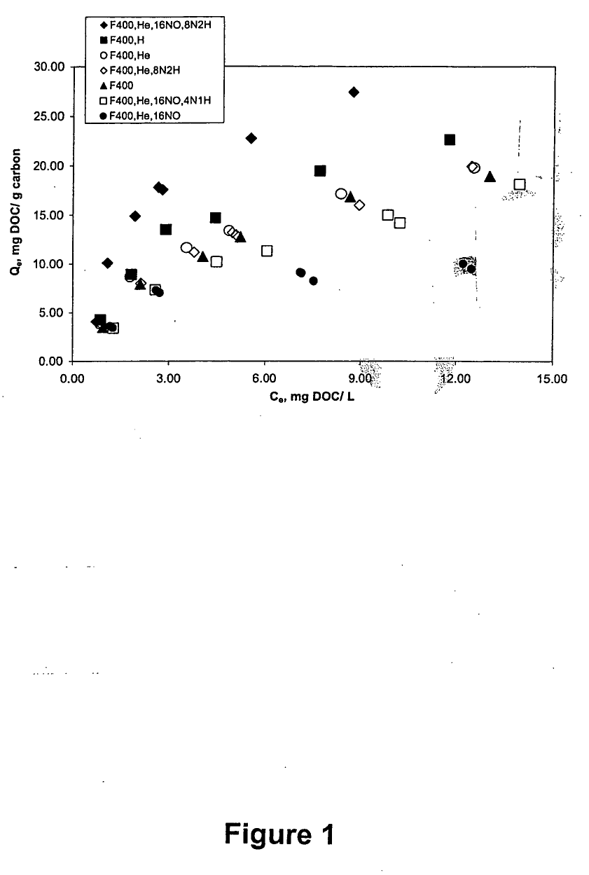

A coal-based, microporous, steam-activated carbon, F400, available from the Calgon Corporation, was utilized as a starting material. The F400 GAC was treated according various combinations and orders of treatment methods, as described above, including heat treatment under helium or hydrogen flow, oxidation with nitric acid, and ammonia treatments. Physical and chemical characteristics of the virgin and treated materials are listed in Table 1, below. Adsorption isotherms of DOM by the materials on a mass basis are graphically illustrated in FIG. 1.

TABLE 1

| | SA_{BET} | SA > 1 nm | | NaOH | HCl | Fe | atomic | atomic |
|---|---|---|---|---|---|---|---|---|
| Carbon | (m²/g) | (m²/g) | pH_{PZC} | meq/g | meq/g | wt % | % N | % O |
| F400 | 1035 | 208 | 8.5 | 0.238 | 0.411 | <0.3 | 0.5 | 5.9 |
| F400, He | 1058 | 230 | 9.8 | 0.098 | 0.494 | <0.3 | 0.4 | 4.6 |
| F400, H | 1084 | 253 | 10.5 | 0.001 | 0.471 | <0.3 | 0.8 | 4.8 |
| F400, He, 16NO | 970 | 243 | 1.9 | 1.864 | 0.097 | <0.3 | 1.2 | 11.3 |
| F400, He, 8N2H | 1001 | 203 | 9.6 | 0.084 | 0.428 | <0.3 | 0.9 | 5.1 |
| F400, He, 16NO, 4N1H | 1005 | 290 | 7.1 | 0.544 | 0.251 | <0.3 | 2.6 | 7.5 |
| F400, He, 16NO, 8N2H | 970 | 354 | 8.5 | 0.201 | 0.476 | <0.3 | 3.9 | 5.7 |

As can be seen by reference to the figure, it is a combination of the surface area available to the large DOM molecules, the surface basicity and the amount of positive charge on these materials that provides for the improvement in the DOM uptake. In this particular example, utilizing a microporous and somewhat basic starting material, the largest improvements were seen in the materials that showed increase in both basicity and positive surface charge. Thus, the DOM uptake of these positively charged materials (at the pH of the experiments) is governed mainly by the accessible surface area. In particular, the extremely high DOM uptake of F400,He,16NO,8N2H appears to be primarily due to enlargement of the carbon pores during the high temperature ammonia treatment.

### EXAMPLE 2

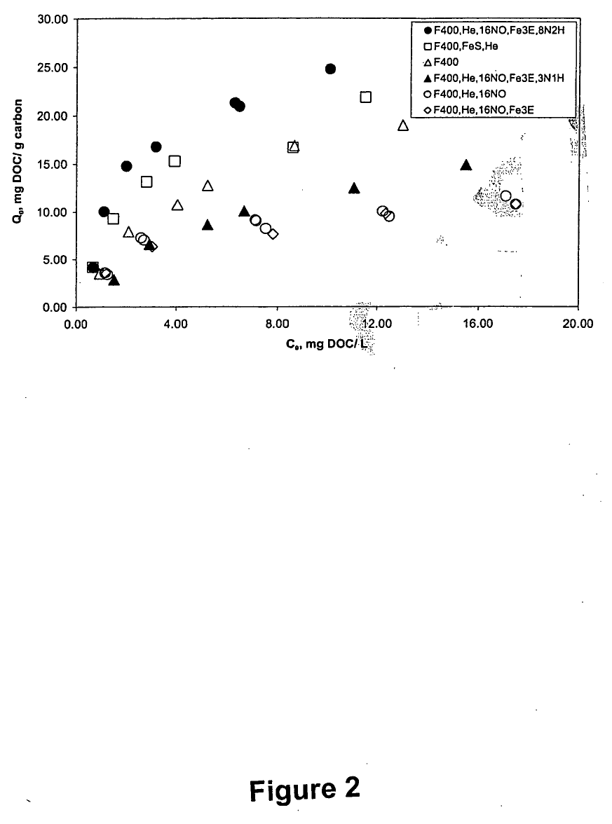

The F400 materials of Example 1 were treated as described above, with the inclusion of the iron impregnation processes. Physical and chemical characteristics of the virgin and treated materials are listed in Table 2, below. Adsorption isotherms of DOM by the materials on a mass basis are graphically illustrated in FIG. 2.

TABLE 2

| | SA_{BET} | SA > 1 nm | | NaOH | HCl | Fe | Atomic | Atomic |
|---|---|---|---|---|---|---|---|---|
| Carbon | (m²/g) | (m²/g) | pH_{PZC} | meq/g | meq/g | wt % | % N | % O |
| F400 | 1035 | 208 | 8.5 | 0.238 | 0.411 | <0.3 | 0.5 | 5.9 |
| F400, Fe3E | 1005 | 210 | 4.2 | 1.343 | 0.129 | 0.5 | 0.9 | 5.7 |
| F400, He, 16NO, | 926 | 248 | 3.2 | 1.847 | 0.089 | 2.3 | 1.1 | 13.9 |
| Fe3E | | | | | | | | |
| F400, He, 16NO, | 884 | 234 | 6.1 | 0.972 | 0.271 | 2.1 | 2.3 | 9.7 |
| Fe3E, 3N1H | | | | | | | | |
| F400, He, 16NO, | 803 | 279 | 9.8 | 0.203 | 0.254 | 5.7 | 1.1 | 6.7 |
| Fe3E, 8N2H | | | | | | | | |
| F400, FeS, He | 934 | 205 | ND | 0.707 | 0.053 | 2.0 | 0.5 | 5.8 |

As described above, iron impregnation, when followed by heat treatment under helium (which decreases surface acidity) and even more so when followed by high temperature ammonia treatment (providing nitridation and pore enlargement), can improve DOM uptake of the materials. In addition, the negative effects on DOM uptake of processes which increase the acidity of the materials (nitric acid treatment and iron impregnation, when followed by low temperature ammonia treatment) are illustrated by poor DOC uptake.

### EXAMPLE 3

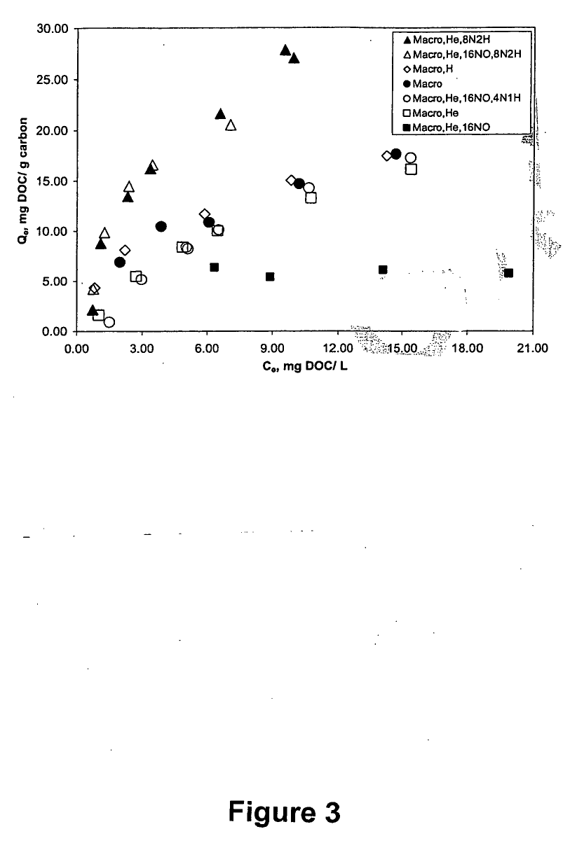

A wood-based, mesoporous, acid-activated carbon, Macro, available from Westvaco, Inc., was utilized as a starting material. The Macro GAC was treated according various combinations and orders of treatment methods, as described above, including heat treatment under helium or hydrogen flow, oxidation with nitric acid, and ammonia treatments. Physical and chemical characteristics of the virgin and treated materials are listed in Table 3, below. Adsorption isotherms of DOM by the materials on a mass basis are graphically illustrated in FIG. 3.

TABLE 3

| | SA_{BET} | SA > 1 nm | | NaOH | HCl | Fe | atomic | atomic |
|---|---|---|---|---|---|---|---|---|
| Carbon | (m²/g) | (m²/g) | pH_{PZC} | meq/g | meq/g | wt % | % N | % O |
| Macro | 1569 | 655 | 1.9 | 1.232 | 0.000 | <0.1 | 0.7 | 7.5 |
| Macro, He | 1261 | 452 | 2.8 | 0.637 | 0.000 | <0.1 | 0.8 | 5.8 |
| Macro, H | 1358 | 512 | 4.5 | 0.649 | 0.000 | <0.1 | 0.5 | 5.3 |
| Macro, He, 16NO | 808 | 284 | 1.9 | 3.570 | 0.000 | <0.1 | 2.4 | 14.0 |
| Macro, He, 8N2H | 1276 | 427 | 7.2 | 0.431 | 0.259 | <0.1 | 1.8 | 4.1 |
| Macro, He, 16NO, | 996 | 367 | 5.7 | 1.112 | 0.061 | <0.1 | 4.1 | 8.6 |
| 4N1H | | | | | | | | |
| Macro, He, 16NO, | 1767 | 712 | 6.9 | 0.425 | 0.508 | <0.1 | 4.5 | 4.1 |
| 8N2H | | | | | | | | |

As shown, hydrogen and helium treatment can remove a considerable portion of surface acidity, and can improve DOM uptake somewhat but the carbons still remain acidic after these treatments. The greatest improvement in uptake for these acidic, mesoporous materials are a combination of treatments that decrease the surface acidity (e.g., He) with treatments that increase the overall surface basicity (e.g., creating nitrogen functionalities with high temperature ammonia treatment 8N2H and 16NO,8N2H).

### EXAMPLE 4

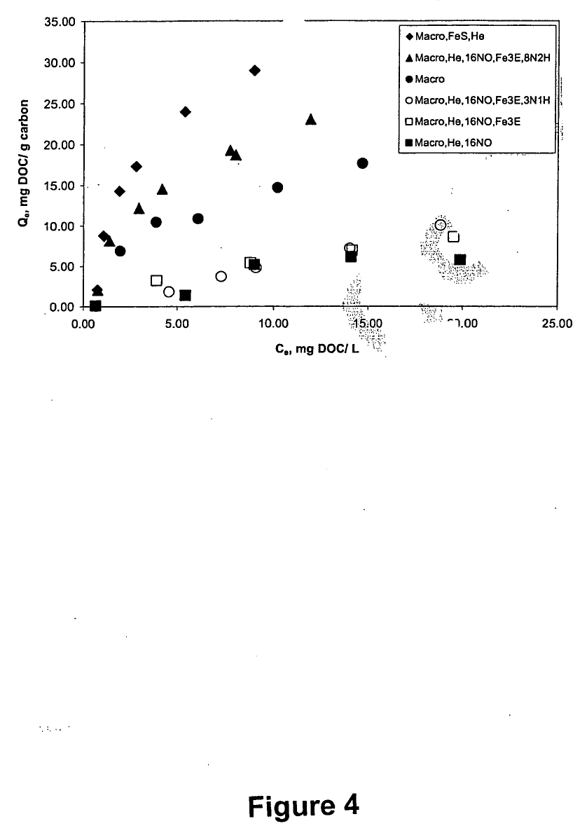

The Macro materials of Example 3 were treated as described above, with the inclusion of the iron impregnation processes. Physical and chemical characteristics of the virgin and treated materials are listed in Table 4, below. Adsorption isotherms of DOM by the materials on a mass basis are graphically illustrated in FIG. 4.

TABLE 4

| | SA_{BET} | SA > 1 nm | | NaOH | HCl | Fe | atomic | atomic |
|---|---|---|---|---|---|---|---|---|
| Carbon | (m²/g) | (m²/g) | pH_{PZC} | meq/g | meq/g | wt % | % N | % O |
| Macro | 1569 | 655 | 1.9 | 1.232 | 0.000 | <0.1 | 0.7 | 7.5 |
| Macro, Fe3E | 1428 | 584 | 3.7 | 1.137 | 0.047 | 1.3 | 1.0 | 8.1 |
| Macro, He, 16NO, | 635 | 213 | 3.0 | 3.952 | 0.221 | 4.7 | 2.6 | 15.2 |
| 8N2H | | | | | | | | |
| Macro, He, 16NO, | 703 | 228 | 5.8 | ND | ND | 5.2 | 4.7 | 11.2 |
| Fe3E, 3N1H | | | | | | | | |
| Macro, He, 16NO, | 683 | 148 | 9.3 | ND | ND | 9.4 | 1.0 | 7.9 |
| Fe3E, 8N2H | | | | | | | | |
| Macro, FeS, He | 1216 | 434 | 7.3 | 0.471 | 0.029 | 7.7 | 0.4 | 11.4 |

DOM isotherms of Macro carbons impregnated with iron followed by ammonia treatment showed trends similar to those observed for F400 carbons (FIG. 4). In particular, low temperature ammonia treatment did not improve the DOM adsorption, apparently due to unfavorable acidity was well as low mesoporosity. High temperature ammonia-treated carbon has a low mesopore volume and accessible surface area (compared to virgin materials), a low nitrogen content, and basic characteristics. The high DOM uptake of this carbon, despite its low accessible surface area, can be attributed to its high iron content and surface basicity.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A method for forming a granular activated carbon comprising:
providing a carbon-based material for forming a granular activated carbon; and
impregnating the carbon-based material with an iron species
wherein the granular activated carbon formed by the process comprises at least about 100 m²/g of surface area distributed in pores having an average diameter of greater than about 1 nm.

2. The method of claim 1, further comprising granulating the carbon-based material.

3. The method of claim 1, further comprising increasing the amount of the surface area of the carbon-based material distributed in pores greater than about 1 nm in average diameter.

4. The method of claim 1, further comprising increasing the overall positive surface charge of the carbon-based material as measured by the pH_{PZC} by at least about 4 pH units.

5. The method of claim 1, wherein the granular activated carbon formed by the process comprises at least about 500 m²/g of surface area distributed in pores greater than about 1 nm in average diameter.

6. The method of claim 1, wherein the carbon-based material is impregnated with an iron species selected from the group consisting of iron oxides, iron hydroxides, iron salts, and organic iron compounds.

7. The method of claim 1, wherein the carbon-based material is impregnated with an iron species have an oxidation state of +2 or +3.

8. The method of claim 1, further comprising increasing the basicity of the carbon-based material.

9. The method of claim 8, wherein the step of increasing the basicity of the carbon-based material comprises heat treatment of the carbon-based material under helium, hydrogen, or steam.

10. The method of claim 8, wherein the step of increasing the basicity of the carbon-based material comprises contacting the carbon-based material with gaseous ammonia.

11. The method of claim 10, wherein the ammonia gas is at a temperature greater than about 500° C.

12. The method of claim 10, further comprising oxidizing the carbon-based material prior to contacting the carbon-based material with gaseous ammonia.

13. The method of claim 1, wherein the carbon-based material is selected from the group consisting of wood, coal, peat, pitch, tar, recycled waste materials, and mixtures thereof.

14. A method for forming a granular activated carbon comprising:
providing a carbon-based material for forming a granular activated carbon;
increasing the amount of the surface area of the carbon-based material distributed in pores greater than about 1 nm in size; and
increasing the basicity of the carbon-based material;
wherein the granular activated carbon formed according to the process comprises at least about 100 m²/g of surface area distributed in pores greater than about 1 nm in size.

15. The method of claim 14, further comprising granulating the carbon-based material.

16. The method of claim 14, further comprising increasing the overall positive surface charge of the carbon-based material.

17. The method of claim 16, wherein the overall positive surface charge of the carbon-based material as measured by the pH_{PZC} is increased by at least about 4 pH units.

18. The method of claim 14, wherein prior to the step of increasing the amount of surface area distributed in pores greater than about 1 nm in size, the carbon-based material comprises at least about 200 m²/g of surface area in pores greater than about 1 nm in average diameter.

19. The method of claim 14, further comprising impregnating the carbon-based material with one or more iron species having an oxidation state of +2, +3, or mixtures of both.

20. A granular activated carbon comprising at least about 1% by weight impregnated iron and an overall positive surface charge as measured by the pH_{PZC} of at least about 7.

21. The granular activated carbon of claim 20, comprising at least about 4% by weight impregnated iron.

22. The granular activated carbon of claim 20, further comprising at least about 100 m²/g of surface area in pores greater than about 1 nm.

23. The granular activated carbon of claim 20, further comprising at least about 500 m²/g of surface area in pores greater than about 1 nm.

24. The granular activated carbon of claim 20, further comprising a basicity as measured by the uptake of HCl of at least about 0.2 meq/g.

25. The granular activated carbon of claim 20, further comprising a basicity as measured by the uptake of HCl of at least about 0.4 meq/g.

26. The granular activated carbon of claim 20, further comprising a basicity as measured by the uptake of HCl of at least about 0.5 meq/g.

27. The granular activated carbon of claim 20, wherein the granular activated carbon is a coal-based carbon or a wood-based carbon.

28. A method for removing dissolved organic matter from natural waters comprising contacting natural waters comprising dissolved organic carbon with mesoporous granular activated carbon comprising at least about 1% by weight impregnated iron and an overall positive surface charge as measured by the pH_{PZC} of at least about 7.

29. The method of claim 28, wherein the mesoporous granular activated carbon comprises at least about 100 m²/g of surface area in pores having an average diameter of greater than about 1 nm.

30. The method of claim 28, wherein the granular activated carbon comprises a basicity as measured by the uptake of HCl of at least about 0.2 meq/g.

31. The granular activated carbon of claim 28, wherein the granular activated carbon is a coal-based carbon or a wood-based carbon.
